(19) United States
(12) Patent Application Publication
(10) Pub. No.: US 2014/0341666 A1
(43) Pub. Date: Nov. 20, 2014

(54) BORING HEAD

(71) Applicant: Chin-Chiu CHEN, Taichung City (TW)

(72) Inventor: Chin-Chiu CHEN, Taichung City (TW)

(21) Appl. No.: 13/896,630

(22) Filed: May 17, 2013

(51) Int. Cl. B23B 29/034

(52) U.S. Cl. CPC B23B 29/03407; B23B 2229/00; B23B 2205/04
USPC 408/147

(57) ABSTRACT

A boring head has a connecting rod, an extending bracket, a cutter mount, and a cutter. The extending bracket is securely connected with the connecting rod. The cutter mount is detachably connected with a front end of the extending bracket. As the cutter mount is detachably connected with the extending bracket, the cutter mount is replaceable, and the length of the cutter mount can be adjusted to produce a bore with a desired diameter.

### BACKGROUND OF THE INVENTION

1. Field of the Invention

The present invention relates to a boring head, and more particularly to a boring head with a replaceable design.

2. Description of Related Art

With reference to FIG. 7, a conventional boring head 50 has a connecting rod 51 and a cutter 52. The connecting rod 51 has a round cross section and a top end. The cutter 52 is securely mounted on the top end of the connecting rod 51.

The connecting rod 51 of the boring head 50 is inserted into and positioned by a base 60. Accordingly, the boring head 50 is securely mounted on the base 60 for subsequent boring operations.

However, the boring head 50 does not have any extending mechanism and a latitudinal length of the boring head cannot be adjusted. Consequently, the boring head 50 has to be replaced every time a desired diameter of a bore is changed. Consequently, multiple boring heads 50 with different lengths have to be prepared, and a cost of purchasing different boring heads 50 is increased. Further, assembling and disassembling the boring head 50 each time the boring head 50 is replaced also causes great inconvenience.

To overcome the shortcomings, the present invention provides a boring head to mitigate the aforementioned problems.

### SUMMARY OF THE INVENTION

The main objective of the invention is to provide a boring head with a replaceable design.

A boring head has a connecting rod, an extending bracket, a cutter mount, and a cutter. The extending bracket is securely connected with the connecting rod. The cutter mount is detachably connected with a front end of the extending bracket. As the cutter mount is detachably connected with the extending bracket, the cutter mount is replaceable, and the length of the cutter mount can be adjusted to produce a bore having a desired diameter.

Other objects, advantages and novel features of the invention will become more apparent from the following detailed description when taken in conjunction with the accompanying drawings.

### BRIEF DESCRIPTION OF THE DRAWINGS

FIG. 1 is a perspective front view of a first embodiment of a boring head in accordance with the present invention;

FIG. 2 is a partially exploded perspective view of the boring head in FIG. 1;

FIG. 3 is a partially exploded perspective view of the boring head in FIG. 1 and an adjusting base;

FIG. 4 is a side view in partial section of the boring head and the adjusting base in FIG. 3;

FIG. 5 is an operational side view of the boring head and the adjusting base in FIG. 4 showing that the boring head is latitudinally moved;

FIG. 6 is a side view of a second embodiment of the boring head in accordance with the present invention; and

FIG. 7 is a perspective view of a conventional boring head in accordance with the prior art, showing that the boring head is inserted into a base.

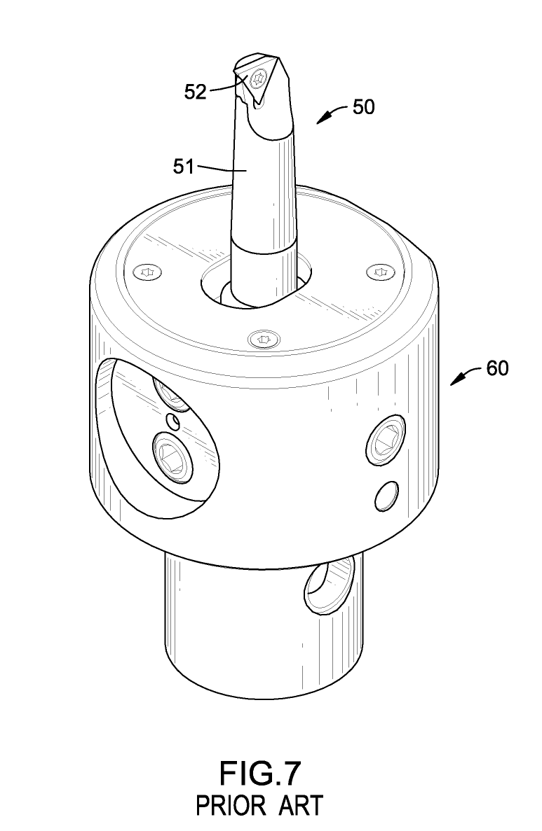

### DETAILED DESCRIPTION OF PREFERRED EMBODIMENT

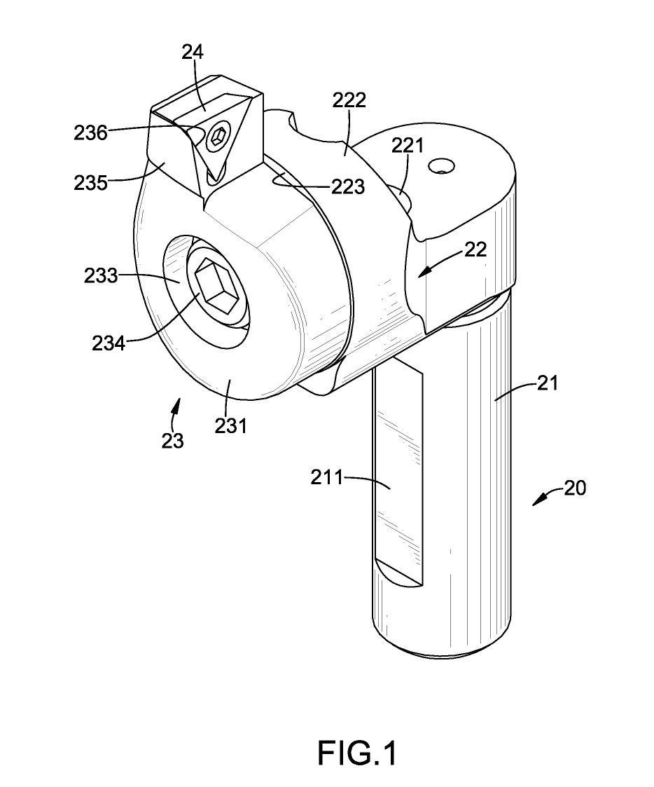

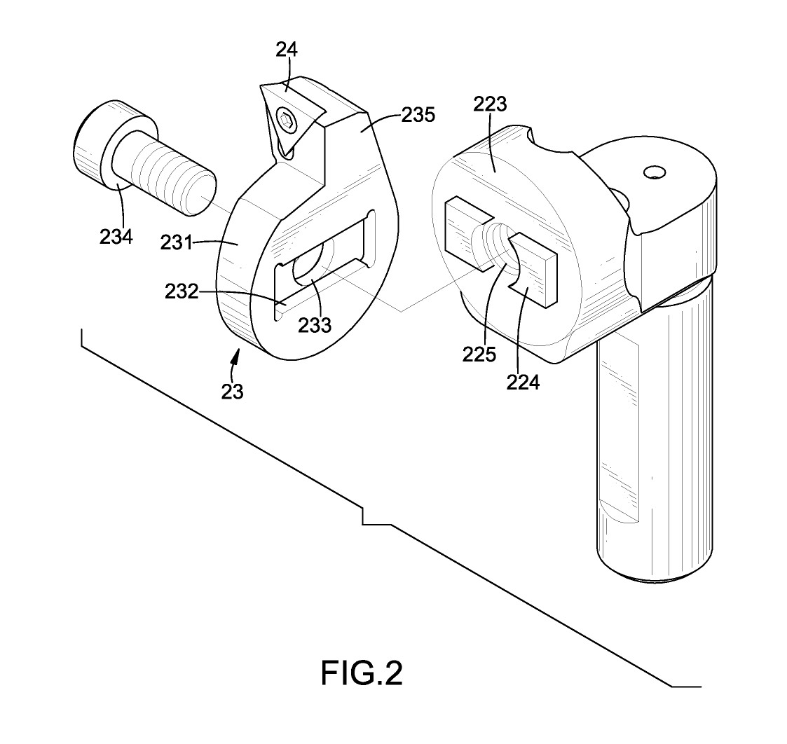

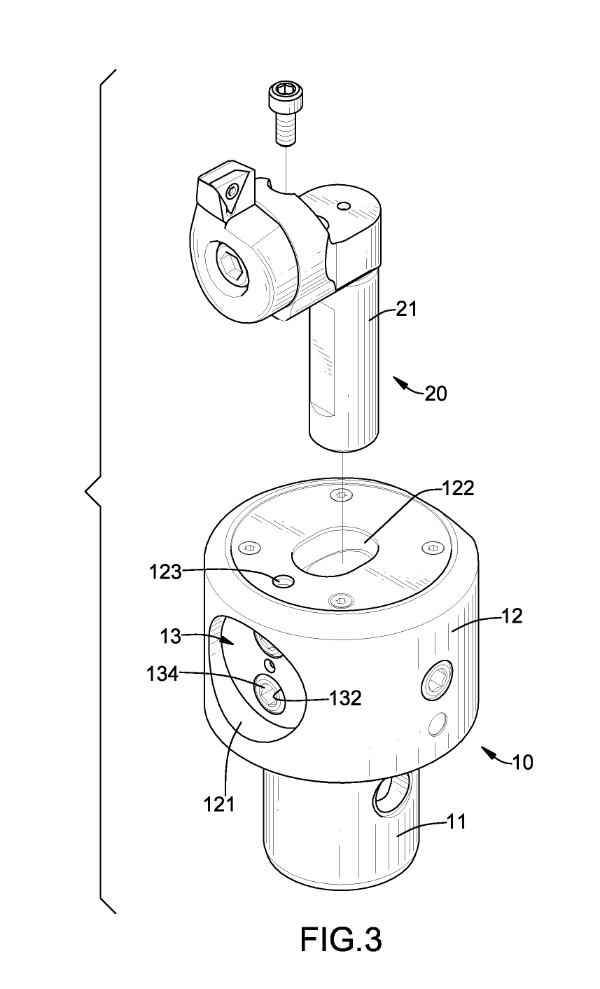

With reference to FIGS. 1 to 4, a first embodiment of a boring head 20 in accordance with the present invention is connected with an adjusting base 10.

The adjusting base 10 has a post 11, a chunk 12, a movable member 13, and a knob 14. The post 11 is linear, is upright, and has a round cross section and a top end.

The chunk 12 is securely mounted on the top end of the post 11, is cylindrical, and has a diameter, a chunk hole 121, a rod hole 122 and a bolt hole 123. The diameter of the chunk 12 is larger than that of the post 11.

The chunk hole 121 is diametrically formed through the chunk 12.

The rod hole 122 is formed in a central section of a top surface of the chunk 12 and communicates with the chunk hole 121.

The bolt hole 123 is formed in the top surface of the chunk 12 and beside the rod hole 122, is parallel to the rod hole 122, and is threaded.

The movable member 13 is slidably mounted in and along the chunk hole 121, and has a first side surface, a second side surface, a member hole 131, two threaded member holes 132, a knob hole 133, two member bolts 134, and a positioning bolt 135. The second side surface of the movable member 13 is opposite to the first side surface of the movable member 13.

The member hole 131 is longitudinally formed through the movable member 13 and faces the rod hole 122.

The threaded member holes 132 are formed in the first side surface of the movable member 13.

The knob hole 133 is formed in the second side surface of the movable member 13, and is threaded.

The two member bolts 134 are respectively screwed into the threaded member holes 132.

The positioning bolt 135 is screwed into the bolt hole 123.

The knob 14 is rotatably connected with the movable member 13, is capable of rotating idly, and has an axle 141 screwed into the knob hole 133. When the knob 14 is turned, the axle 141 is rotated at the same place, and the movable member 13 is moved along the axle 141 and along the chunk hole 121.

With reference to FIGS. 1 to 4, the boring head 20 has a connecting rod 21, an extending bracket 22, a cutter mount 23 and a cutter 24.

The connecting rod 21 is linear, is inserted into the rod hole 122 and has a top end, an outer surface and a pressed surface 211. The pressed surface 211 is flat, is formed at the outer surface of the connecting rod 21, extends longitudinally, and is pressed against by the two member bolts 134.

The extending bracket 22 is securely connected with the connecting rod 21, abuts on the top surface of the chunk 12, extends horizontally and has a front end, a rear end, an auxiliary hole 221 and a plate portion 222.

The rear end of the extending bracket 22 is opposite to the front end of the extending bracket 22 and is securely connected with the top end of the connecting rod 21.

The auxiliary hole 221 is elongated, is formed through the extending bracket 22 and extends toward the front end and the rear end of the extending bracket 22. The positioning bolt 135 is mounted through the auxiliary hole 221.

The plate portion 222 is formed at the front end of the extending bracket 22. Preferably, the plate portion 222 of the extending bracket 22 has a front surface 223, a threaded bracket hole 225, and two bracket protrusions 224. The front surface 223 of the plate portion 222 is flat. The threaded bracket hole 225 is formed in a central section of the front surface 223 of the plate portion 222. The two bracket protrusions 224 protrude from the front surface 223, and are respectively located at two opposite sides of an opening of the threaded bracket hole 225.

The cutter mount 23 is detachably connected with the plate portion 222 of the extending bracket 22 and has a plate section 231.

The plate section 231 abuts on the front surface 223 of the plate portion 222 of the extending bracket 22 and has a top end, a front end, a rear end, a mount recess 232, a mount aperture 233, a protuberance 235, and a cutter recess 236. The rear end of the plate section 231 is opposite to the front end of the plate section 231 of the cutter mount 23 and abuts on the front surface 223 of the plate portion 222.

The mount recess 232 is formed in the rear end of the plate section 231 such that the two bracket protrusions 224 are securely positioned by the mount recess 232.

The mount aperture 233 is formed through the front end and the rear end of the plate section 231 and is formed through a central section of the mount recess 232.

A mount bolt 234 is mounted through the mount aperture 233 and is screwed into the threaded bracket hole 225 such that the cutter mount 23 is securely connected with the extending bracket 22.

The protuberance 235 is formed on the top end of the plate section 231, and protrudes upwardly.

The cutter recess 236 is formed in the protuberance 235.

The cutter 24 is securely connected with the cutter mount 23 and is mounted in the cutter recess 236.

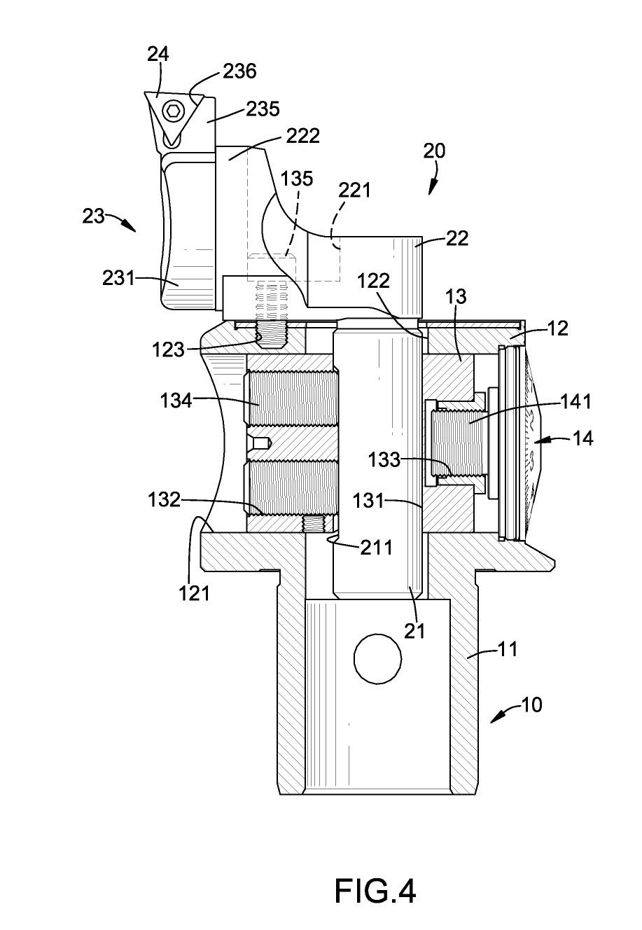

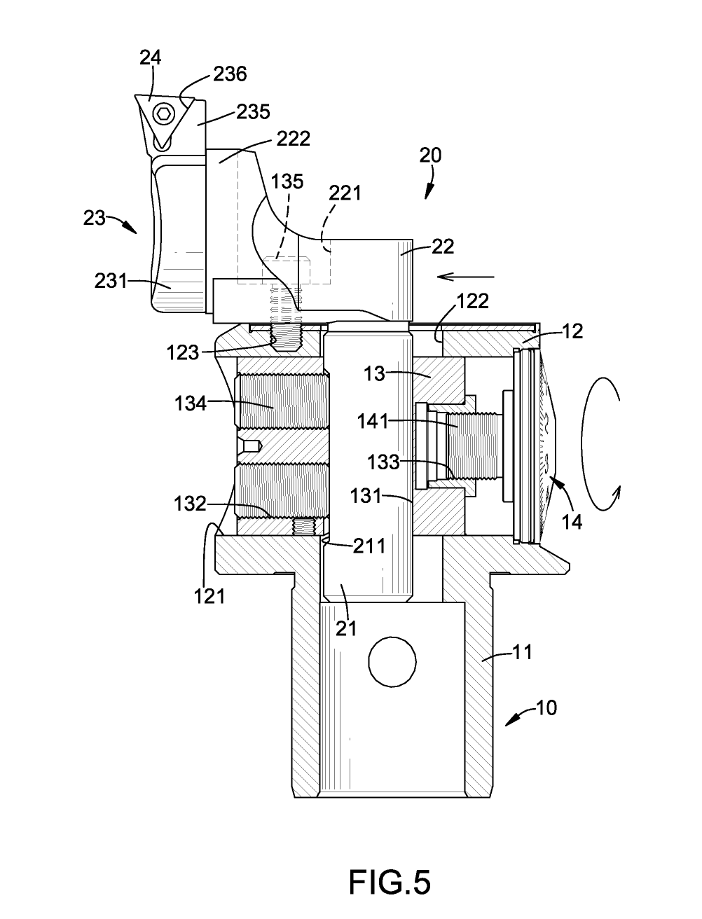

With reference to FIGS. 4 and 5, the boring head 20 in accordance with the present invention is mounted on the adjusting base 10 and is to be moved latitudinally. The connecting rod 21 of the boring head 20 is inserted into the rod hole 122 and the member hole 131, and is pressed against by the member bolts 134 for being securely positioned.

The positioning bolt 135 is mounted through the auxiliary hole 221 and is screwed into the bolt hole 123. Accordingly, the boring head 20 is securely mounted on the adjusting base 10 for subsequent boring operations.

When the boring head 20 is moved latitudinally, a desired diameter of a bore can be adjusted. The procedures of moving the boring head 20 are as follows.

First, the positioning bolt 135 is loosened. The knob 14 is rotated such that the movable member 13 with the connecting rod 21 is moved along the axle 141 and the chunk hole 121. Accordingly, the boring head 20 is moved latitudinally to a desired position. Second, the positioning bolt 135 is screwed into the bolt hole 123 again to secure the boring head 20.

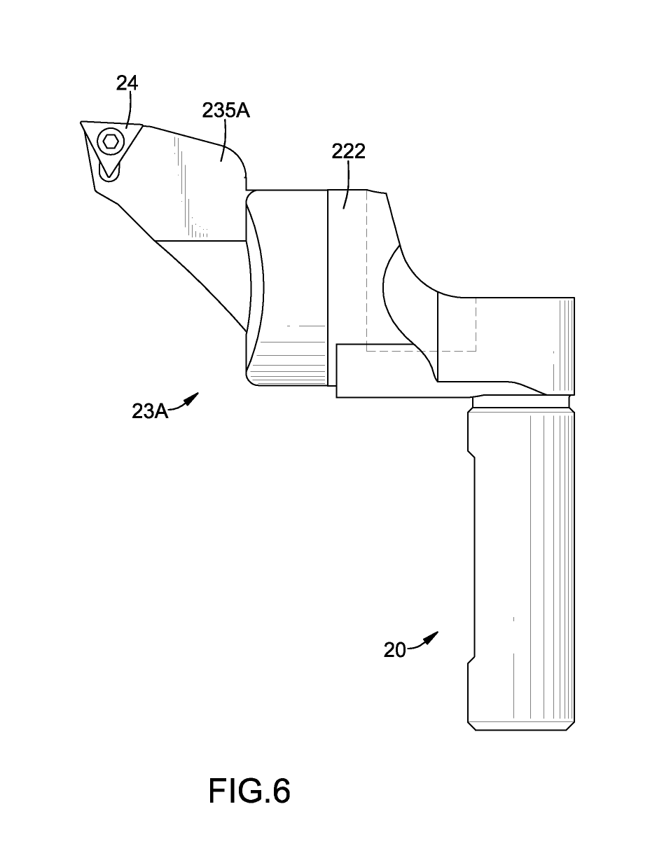

As the cutter mount 23 is detachably connected with the extending bracket 22, the cutter mount 23 is replaceable. When the desired diameter of the bore is large and beyond an adjusting range of the adjusting base 10, the original cutter mount 23 can be replaced with another new extending cutter mount 23A. For example, a second embodiment of the boring head having a different protuberance 235A is as shown in FIG. 6.

From the above description, it is noted that the present invention has the following advantages:

1. Replaceable Structure:

As the cutter mount 23,23A is detachably connected with the extending bracket 22, the cutter mount 23,23A is replaceable, and the length of the cutter mount 23,23A can be adjusted to produce a bore with a desired diameter.

2. Cost Reduction:

The cutter mounts 23,23A having different lengths, instead of the entire boring heads, are prepared for replacement. As the cost of the cutter mount 23,23A is lower than the boring heads, the overall cost is remarkably reduced.

3. Fast Assembling:

As the connecting rod 21 does not have to be disassembled from the adjusting base 10, adjusting diameter of the boring head 20 is fast.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A boring head comprising:
a linear connecting rod having a top end;
an extending bracket securely connected with the connecting rod, extending horizontally and having
a front end; and
a rear end opposite to the front end of the extending bracket and securely connected with the top end of the connecting rod;
a plate portion formed at the front end of the extending bracket;
a cutter mount detachably connected with the plate portion of the extending bracket and having
a plate section abutting on the plate portion of the extending bracket and having a top end; and
a protuberance formed on the top end of the plate section and protruding upwardly; and
a cutter recess formed in the protuberance; and
a cutter securely connected with the cutter mount and mounted in the cutter recess.

2. The boring head as claimed in claim 1, wherein
the plate portion of the extending bracket has
a flat front surface;
a threaded bracket hole formed in a central section of the front surface of the plate portion; and
two bracket protrusions protruding from the front surface of the plate portion, respectively located at two opposite sides of an opening of the threaded bracket hole;
the plate section of the cutter mount has
a front end;
a rear end opposite to the front end of the plate section of the cutter mount and abutting on the front surface of the plate portion;
a mount recess formed in the rear end of the plate section such that the two bracket protrusions are securely positioned by the mount recess; and
a mount aperture formed through the front end and the rear end of the plate section and formed through a central section of the mount recess; and
the cutter mount has
a mount bolt mounted through the mount aperture and screwed into the threaded bracket hole such that the cutter mount is securely connected with the extending bracket.

3. The boring head as claimed in claim 1, wherein
the extending bracket has an auxiliary hole; and
the auxiliary hole is elongated, is formed through the extending bracket and extends toward the front end and the rear end of the extending bracket.

4. The boring head as claimed in claim 2, wherein
the extending bracket has an auxiliary hole; and
the auxiliary hole is elongated, is formed through the extending bracket and extends toward the front end and the rear end of the extending bracket.
